(19) United States
(12) Patent Application Publication
(10) Pub. No.: US 2024/0078122 A1
(43) Pub. Date: Mar. 7, 2024

(54) INFORMATION PROCESSING DEVICE, INFORMATION PROCESSING SYSTEM, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventor: Akira HIROSE, Kanagawa (JP)

(73) Assignee: FUJIFILM BUSINESS INNOVATION CORP., Tokyo (JP)

(21) Appl. No.: 18/177,822

(22) Filed: Mar. 3, 2023

(30) Foreign Application Priority Data
Sep. 2, 2022 (JP) 2022-140317

(51) Int. Cl. G06F 9/455

(52) U.S. Cl. CPC G06F 9/45545

(57) ABSTRACT

An information processing device includes a processor configured to function as a virtual device that is provided one-to-one with a physical device and that mediates transmission and reception of information between an application and the physical device. On acceptance of an instruction from the application to read/write information, the virtual device connects to a storage area determined in advance for each content of the information and reads/writes the information.

### CROSS-REFERENCE TO RELATED APPLICATIONS

This application is based on and claims priority under 35 USC 119 from Japanese Patent Application No. 2022-140317 filed Sep. 2, 2022.

### BACKGROUND

### (i) Technical Field

The present disclosure relates to an information processing device, an information processing system, a non-transitory computer readable medium, and an information processing method.

### (ii) Related Art

Japanese Unexamined Patent Application Publication No. 2019-148843 discloses a device management apparatus including a status management unit connected to a device by a communication network, the device being configured to, on receipt of a status change request including a target value indicating a target of a status to be changed by the device and a reservation time, execute a certain operation for achieving the target value at the reservation time, and return a report value indicating the status after the execution, the status management unit being configured to, in response to an input of a status change request, send the status change request to the device, and, in response to an input of a device status inquiry, determine whether the report value has been received after the reservation time has elapsed, and, if no report value has been received, send an estimation value indicating a status estimated from the certain operation.

Technology for transmitting and receiving information by allowing a user's application and a physical device to communicate with each other via a virtual device installed on the cloud in association with the physical device is conceivable. In this technology, there are cases where an area that stores information for a predetermined purpose is prepared in the virtual device, and information defined and used later for managing and operating the physical device is stored in a database or the like that is independent of the virtual device. In this case, the application side is required to give an instruction as to whether to connect to the virtual device or to a device other than the virtual device, and to establish a connection.

### SUMMARY

Aspects of non-limiting embodiments of the present disclosure relate to an information processing device, an information processing system, a non-transitory computer readable medium, and an information processing method capable of reading and writing information without specifying a connection destination on an application side by connecting to a virtual device that is provided one-to-one with a physical device and that mediates the transmission and reception of information between the application and the physical device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to: function as a virtual device that is provided one-to-one with a physical device and that mediates transmission and reception of information between an application and the physical device, wherein, on acceptance of an instruction from the application to read/write information, the virtual device connects to a storage area determined in advance for each content of the information and reads/writes the information.

### BRIEF DESCRIPTION OF THE DRAWINGS

An exemplary embodiment of the present disclosure will be described in detail based on the following figures, wherein:

FIG. 1 is a diagram illustrating a schematic configuration of an image forming system according to an exemplary embodiment;

FIG. 2 is a block diagram illustrating the configuration of the major parts of the electrical system of an image forming device in the image forming system according to the present exemplary embodiment;

FIG. 3 is a block diagram illustrating the configuration of the major parts of the electrical system of a local server, a cloud server, a client terminal, and a communication terminal according to the present exemplary embodiment;

FIG. 4 is a diagram illustrating an example of a management application that centrally handles information on real devices from the current status of consumables to asset inventory;

FIG. 5 is a diagram illustrating an example of a screen that collectively displays information on a real device on the management application;

FIG. 6 is a diagram illustrating an example of information stored in an inventory database (DB);

FIG. 7 is a diagram illustrating an example of a list of real devices managed by the management application;

FIG. 8 is a block diagram illustrating an example of an extended virtual device provided with an extended storage area by extending a virtual device;

FIG. 9 is a diagram illustrating an example of inventory record information stored in the extended storage area;

FIG. 10 is a diagram illustrating an example of a device list;

FIG. 11 is a diagram illustrating an example of access destinations according to the type of information as a distinguishing rule;

FIG. 12 is a flowchart illustrating an example of the flow of processing performed by the cloud server in an information processing system according to the exemplary embodiment;

FIG. 13 is a block diagram illustrating a modification of the extended virtual device;

FIG. 14 is a diagram illustrating an example of data stored in a DB server; and

FIG. 15 is a diagram illustrating an example of access destinations according to the type of information as a distinguishing rule.

### DETAILED DESCRIPTION

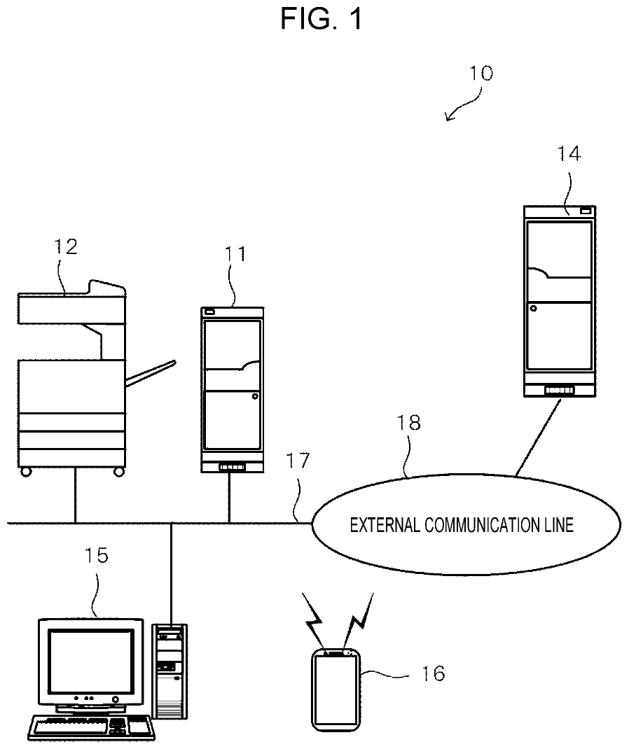

Hereinafter, an exemplary embodiment of the present disclosure will be described in detail with reference to the drawings. FIG. 1 is a diagram illustrating a schematic configuration of an image forming system according to the present exemplary embodiment. In the present exemplary embodiment, an image forming system 10 will be described as an example of an information processing system.

The image forming system 10 according to the present exemplary embodiment includes, as illustrated in FIG. 1, a local server 11, an image forming device 12 as an example of a physical device, a cloud server 14 as an example of an information processing device, a client terminal 15, and a communication terminal 16. Although only one local server 11, one image forming device 12, one cloud server 14, one client terminal 15, and one communication terminal 16 are illustrated in the present exemplary embodiment, they may each be plural. In addition, the local server 11 may be omitted.

The local server 11, the image forming device 12, and the client terminal 15 are connected to an internal communication line 17 such as a local area network (LAN), an intranet, or the like. The internal communication line 17 and the cloud server 14 are connected to an external communication line 18 such as a wide area network (WAN), the Internet, or the like. Moreover, the communication terminal 16 carried by a user is configured to be connectable to the internal communication line 17 and the external communication line 18. The local server 11, the image forming device 12, the cloud server 14, the client terminal 15, and the communication terminal 16 are each configured to be able to transmit and receive various types of data to and from each other via the internal communication line 17 and the external communication line 18. Note that, as an example of the communication terminal 16, a mobile phone such as a smart phone, a notebook personal computer (PC), or the like is applied, and FIG. 1 illustrates an example of a mobile phone.

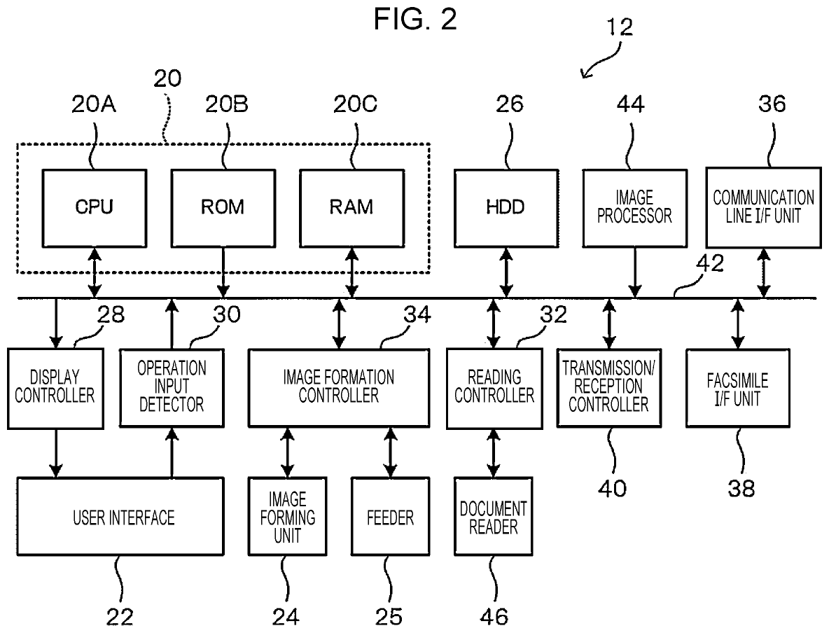

FIG. 2 is a block diagram illustrating the configuration of the major parts of the electrical system of the image forming device 12 in the image forming system 10 according to the present exemplary embodiment.

The image forming device 12 according to the present exemplary embodiment includes, as illustrated in FIG. 2, a control unit 20, which includes a central processing unit (CPU) 20A, a read-only memory (ROM) 20B, and a random-access memory (RAM) 20C. The CPU 20A controls the entire operation of the image forming device 12. The RAM 20C is used as a work area or the like when the CPU 20A executes various programs. The ROM 20B stores in advance various control programs, various parameters, and the like. In the image forming device 12, the individual parts of the control unit 20 are electrically connected by a system bus 42.

The image forming device 12 according to the present exemplary embodiment also includes a hard disk drive (HDD) 26, which stores various types of data, application programs, and the like. The image forming device 12 further includes a display controller 28, which is connected to a user interface 22 and which controls displaying of various operation screens on a display of the user interface 22. In addition, the image forming device 12 includes an operation input detector 30, which is connected to the user interface 22 and which detects operation instructions input via the user interface 22. In the image forming device 12, the HDD 26, the display controller 28, and the operation input detector 30 are electrically connected to the system bus 42. Although an example in which the image forming device 12 according to the present exemplary embodiment includes the HDD 26 is discussed, this is not the only possible case, and the image forming device 12 may include a non-volatile memory such as flash memory.

Moreover, the image forming device 12 according to the present exemplary embodiment includes a reading controller 32, which controls the optical image reading operation of a document reader 46 and the document feed operation of a document feeder, and an image formation controller 34, which controls the image formation processing performed by an image forming unit 24 and the feeding of paper to the image forming unit 24 by a feeder 25. The image forming device 12 also includes a communication line interface (communication line I/F) unit 36, which is connected to the internal communication line 17 and which transmits and receives communication data to and from other devices connected to the internal communication line 17, and an image processor 44, which performs various types of image processing. Moreover, the image forming device 12 includes a facsimile interface (facsimile I/F) unit 38, which is connected to a phone line (not illustrated) and which transmits and receives facsimile data to and from facsimile machines connected to the phone line. The image forming device 12 also includes a transmission/reception controller 40, which controls the transmission and reception of facsimile data via the facsimile interface unit 38. In the image forming device 12, the transmission/reception controller 40, the reading controller 32, the image formation controller 34, the communication line interface unit 36, the facsimile interface unit 38, and the image processor 44 are electrically connected to the system bus 42.

With the above configuration, the image forming device 12 according to the present exemplary embodiment executes, with the CPU 20A, access to the RAM 20C, the ROM 20B, and the HDD 26. Furthermore, the image forming device 12 executes control of, with the CPU 20A, displaying of information such as operation screens and various messages on the display of the user interface 22 via the display controller 28. The image forming device 12 also executes control of, with the CPU 20A, the operation of the document reader 46 and the document feeder via the reading controller 32. In addition, the image forming device 12 controls, with the CPU 20A, the operation of the image forming unit 24 and the feeder 25 via the image formation controller 34, and the transmission and reception of communication data via the communication line interface unit 36. In addition, the image forming device 12 executes control of, with the CPU 20A, the transmission and reception of facsimile data by the transmission/reception controller 40 via the facsimile interface unit 38. Furthermore, the image forming device 12 grasps, with the CPU 20A, operation contents of the user interface 22 based on operation information detected by the operation input detector 30, and executes various types of control based on the operation contents. Note that forming an image on paper may be referred to as printing.

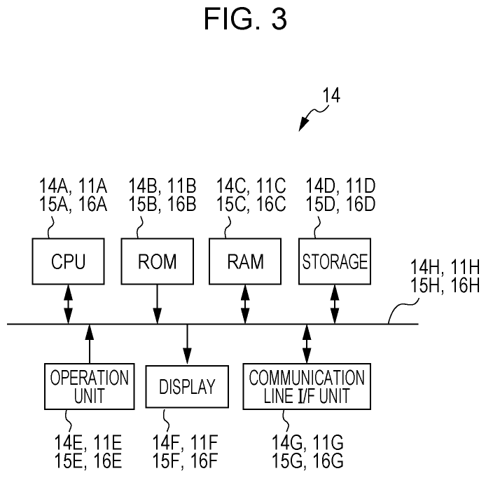

Next, the configuration of the major parts of the electrical system of the local server 11, the cloud server 14, the client terminal 15, and the communication terminal 16 in the image forming system 10 according to the present exemplary embodiment will be described. FIG. 3 is a block diagram illustrating the configuration of the major parts of the electrical system of the local server 11, the cloud server 14, the client terminal 15, and the communication terminal 16 according to the present exemplary embodiment. Since the local server 11, the cloud server 14, the client terminal 15, and the communication terminal 16 basically have the configuration of a general computer, the cloud server 14 will be described as a representative while omitting the description of the local server 11, the client terminal 15, and the communication terminal 16, and only corresponding reference symbols are indicated in FIG. 3.

The cloud server 14 according to the present exemplary embodiment includes, as illustrated in FIG. 3, a CPU 14A, a ROM 14B, a RAM 14C, a storage 14D, an operation unit 14E, a display 14F, and a communication line interface (I/F) unit 14G. The CPU 14A controls the entire operation of the cloud server 14. The ROM 14B stores in advance an information processing program for performing various types of control, various parameters, and the like. The RAM 14C is used as a work area or the like when the CPU 14A executes various programs. The storage 14D stores various types of data, application programs, and the like. The operation unit 14E is used for inputting various types of information. The display 14F is used for displaying various types of information. The communication line interface unit 14G is connected to the external communication line 18, and transmits and receives various types of data to and from other devices connected to the external communication line 18. The above units of the cloud server 14 are electrically connected to each other by a system bus 14H. The cloud server 14 according to the present exemplary embodiment includes the storage 14D as a memory, and a non-volatile memory such as an HDD or flash memory is applied as the storage 14D. Note that communication line interface units 11G, 15G, and 16G of the local server 11, the client terminal 15, and the communication terminal 16 are connected to the internal communication line 17 and transmit and receive various types of data to and from other devices connected to the internal communication line 17.

With the above configuration, the cloud server 14 according to the present exemplary embodiment executes, with the CPU 14A, access to the ROM 14B, RAM 14C, and storage 14D, obtaining of various types of data via the operation unit 14E, and displaying of various types of information on the display 14F. The cloud server 14 also executes control of, with the CPU 14A, the transmission and reception of communication data via the communication line interface unit 14G.

In the image forming system 10 according to the present exemplary embodiment configured as above, for example, the local server 11, the image forming device 12, and the client terminal 15 are provided in the company. Then, the use of the image forming device 12 is allowed from the outside using the communication terminal 16 via the cloud server 14.

The cloud server 14 provides the function of a virtual device that functions as the image forming device 12 in conjunction with the image forming device 12. More specifically, in the image forming system 10 according to the present exemplary embodiment, the CPU 14A on the cloud server 14 side functions as a virtual device that is provided one-to-one with a physical device, and that mediates the transmission and reception of information between an application installed in the communication terminal 16 and the physical device. In the following description, the image forming device 12 as an example of a physical device may be referred to as a real device 12.

A virtual device is a modeled device that enables the retention or execution of functions that extend the functions of the real device 12 in conjunction with the real device 12.

A virtual device 50 synchronizes with the real device 12 with predetermined timing, and duplicates and retains information of the real device 12. An example of data to be synchronized includes meta data such as log data, status data, setting information, and machine information including a device name and a model name. When the virtual device 50 and the real device 12 are synchronized, it becomes possible to remotely view the status or change the settings of the real device 12 using the client terminal 15, the communication terminal 16, or the like.

Moreover, the virtual device 50 performs processing with external services via an application programming interface (API). Examples of external services include a machine management service and a printing service.

The machine management service allows a machine administrator who is at a different office or in a different country to access the machine management service to check the status or change the settings of the machine. The machine management service transmits and receives information to and from the virtual device 50. When the machine management service sends a status checking request to the virtual device 50, the virtual device 50 returns the status information. When the machine management service sends a setting change request to the virtual device 50, the setting information of the virtual device 50 is updated. When synchronized with the virtual device 50, the real device 12 obtains the updated setting information and changes the settings of the real device 12.

The printing service allows a mobile terminal such as the communication terminal 16 to upload print data to the printing service, and prints it on the real device 12 having obtained a print job via the virtual device 50.

By the way, in the operation of the real device 12, there occurs a lot of information that the user wants to manage in association with the real device 12. For example, there is a case in which the user wants to record inventory information in association with each real device 12. Such data is required to be managed in a database or the like separately from the real device 12, which is bothersome.

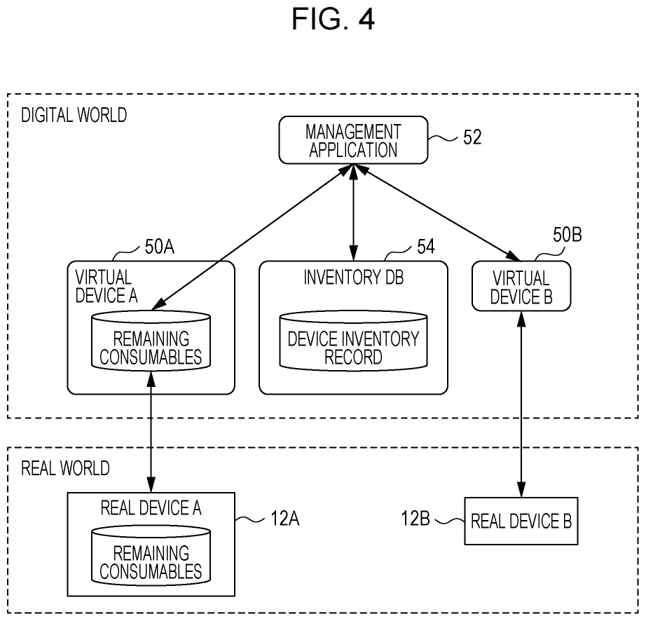

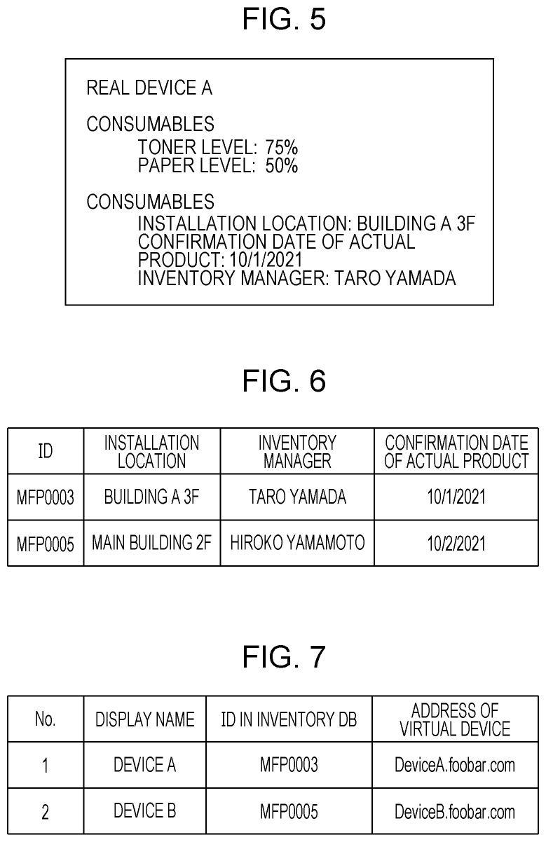

FIG. 4 is a diagram illustrating an example of a management application that centrally handles information on the real devices 12 from the current status of consumables to asset inventory. FIG. 5 is a diagram illustrating an example of a screen that collectively displays information on a real device 12 on the management application.

In the example illustrated in FIG. 4, in order for a management application 52 to display the screen illustrated in FIG. 5, the management application 52 is required to obtain the current status of consumables from a real device A 12A via a virtual device A 50A, and to obtain asset inventory information from an inventory DB 54, distinguishing each real device 12.

The management application 52 is also required to manage how the real device A 12A is represented (for example, the ID number) in the inventory DB 54.

In this case, the inventory DB 54 stores information such as, for example, as illustrated in FIG. 6, the ID, the installation location, the inventory manager, and the confirmation date of the actual product of the real device 12. Then, the management application 52 is required to manage information such as display names, IDs in the inventory DB 54, and the addresses of virtual devices 50, which are illustrated in FIG. 7. Note that FIG. 6 is a diagram illustrating an example of information stored in the inventory DB 54, and FIG. 7 is a diagram illustrating an exemplary list of real devices 12 managed by the management application 52.

Accordingly, in the present exemplary embodiment, in the case where the cloud server 14 functions as a virtual device 50 and the virtual device 50 accepts an instruction from an application such as the management application 52 to read/write information, the virtual device 50 connects to a storage area determined in advance for each content of the information and reads/writes the information.

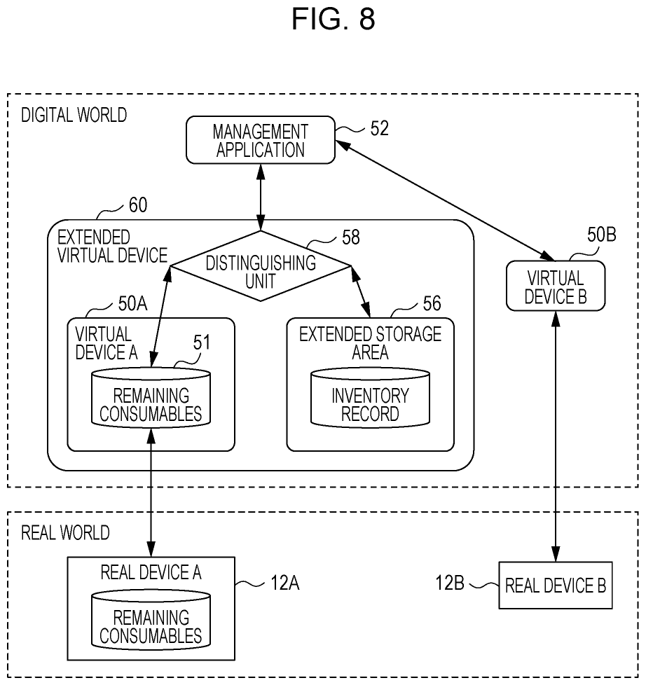

Specifically, as illustrated in FIG. 8, assume that an extended virtual device 60 is provided with an extended storage area 56 by extending the virtual device A 50A. The extended storage area 56 stores information such as an inventory record stored in an external server such as the inventory DB 54. For example, as illustrated in FIG. 9, the value of each label is stored in the extended storage area 56. FIG. 9 is a diagram illustrating an example of inventory record information stored in the extended storage area 56. In contrast, the virtual device 50 includes a duplicate storage area 51 for duplicating and retaining information of the real device 12, and information on consumables of the real device 12 is stored in the duplicate storage area 51.

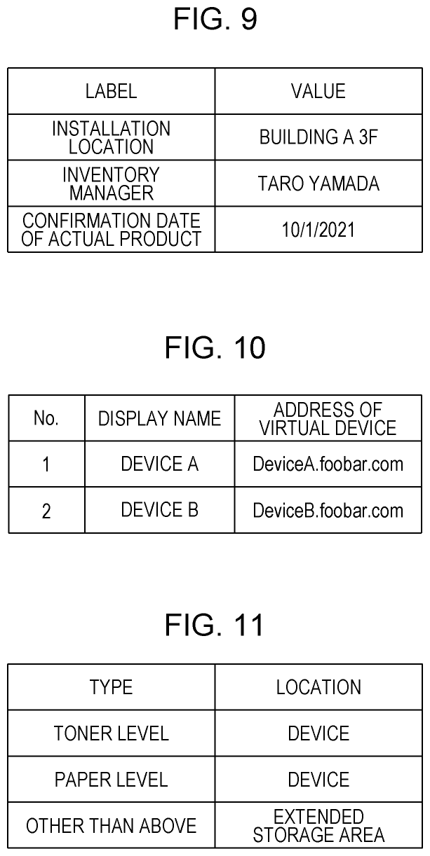

In order to access each virtual device 50, the management application 52 has, as illustrated in FIG. 10, a device list indicating the address of a virtual device 50 corresponding to each real device 12, and accesses the virtual device 50 corresponding to each real device 12 in accordance with the device list.

The virtual device 50 has the function of a distinguishing unit 58, and the distinguishing unit 58 determines the access destination according to the type of requested information in accordance with a distinguishing rule as illustrated in FIG. 11, and reads/writes information. FIG. 11 is a diagram illustrating an example of access destinations according to the type of information as a distinguishing rule. In the example illustrated in FIG. 11, it is illustrated that, as types of information, toner level and paper level reside in the device, and other than toner level and paper level resides in the extended storage area 56.

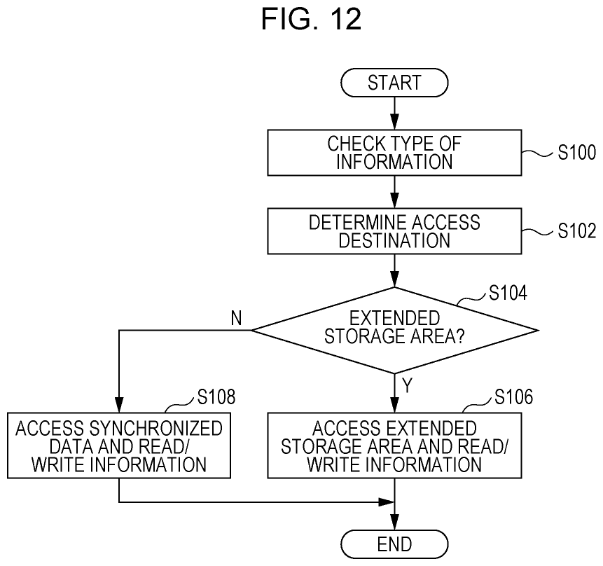

Here, specific processing performed by the cloud server 14 in the image forming system 10 according to the present exemplary embodiment will be described. FIG. 12 is a flowchart illustrating an example of the flow of processing performed by the cloud server 14 in the image forming system 10 according to the present exemplary embodiment. Note that the processing illustrated in FIG. 12 starts when, for example, an information read/write request is received from the management application 52.

In step S100, the CPU 14A checks the type of requested information, and proceeds to step S102.

In step S102, the CPU 14A determines the access destination, and proceeds to step S104. That is, the distinguishing unit 58 determines the access destination in accordance with the distinguishing rule illustrated in FIG. 11.

In step S104, the CPU 14A determines whether to access the extended storage area 56. In the case where the determination is affirmed, the CPU 14A proceeds to step S106; and, in the case of accessing the real device 12, the determination is negated, and the CPU 14A proceeds to step S108.

In step S106, the CPU 14A accesses the extended storage area 56, reads/writes information, and ends the series of steps of the processing.

In contrast, in step S108, the CPU 14A accesses synchronized data that the virtual device 50 is synchronizing with the real device 12, reads/writes information, and ends the series of steps of the processing.

Here, the processing performed by the cloud server 14 will be described in detail using a specific example of the types of information.

For example, suppose that the management application 52 sends the following request to the address (DeviceA.foobar.com) of the virtual device A 50A to obtain the toner level of the real device A 12A.

### <GetRequest>

### <Toner/>

### </GetRequest>

The distinguishing unit 58 of the extended virtual device 60 determines that the requested data (Toner) is one of items of data stored in the real device A 12A. Then, the data of the real device A 12A being cached in the virtual device A 50A is retrieved. Based on the retrieved data, a response message such as, for example, the following is generated and returned from the virtual device A 50A to the management application 52. Note that it is supposed that the data of the real device A 12A being cached in the virtual device A 50A is updated as appropriate with the data of the real device A 12A.

### <GetResult>

### <Toner>50%</Toner>

### </GetResult>

For example, suppose that the management application 52 sends the following request to the address (DeviceA.foobar.com) of the virtual device A 50A to obtain the confirmation date of the actual product of the real device A 12A.

### <GetRequest>

<confirmation date of actual product/>

### </GetRequest>

The distinguishing unit 58 of the extended virtual device 60 determines that the requested data, that is, the confirmation date of the actual product, is not data stored in the real device A 12A. Then, the requested data is searched for in/from the extended storage area 56 of the extended virtual device 60. Based on the retrieved data, a response message such as, for example, the following is generated and returned from the extended virtual device 60 to the management application 52.

### <GetResult>

<confirmation date of actual product>10/1/2021</confirmation date of actual product>

### </GetResult>

In this manner, the management application 52 only communicates with the extended virtual device 60, and data stored in the real device A 12A and data that is not stored in the real device A 12A but is stored in association with the real device A 12A are both obtained in the same manner.

Although the case of reading and obtaining information has been described as an example here, the same applies to the case of writing and storing information.

The type of data stored in the extended storage area 56 may be set in advance, or may be configured to be added from time to time when the extended virtual device 60 receives a storage request for an unknown type of data, such as <scheduled removal date>3/20/2022</scheduled removal date>.

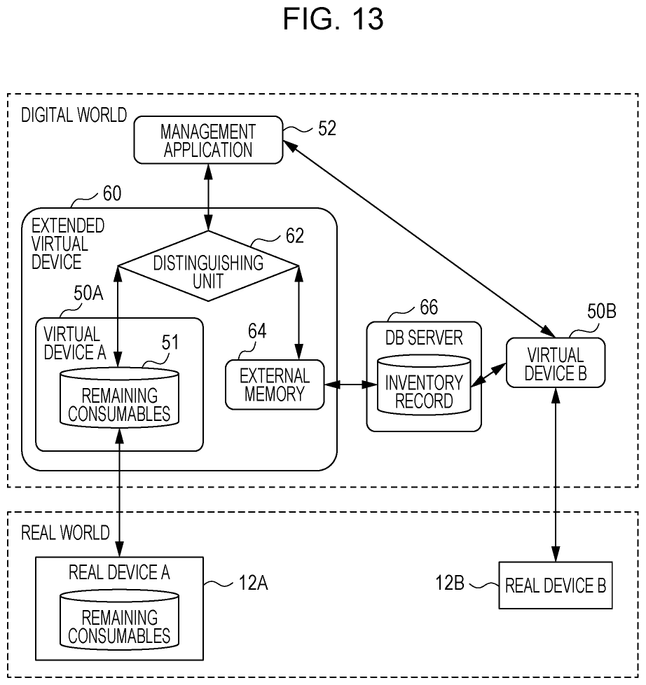

Next, a modification of the above-described extended virtual device 60 will be described. FIG. 13 is a block diagram illustrating a modification of the extended virtual device 60.

In the modification, the extended virtual device 60 is provided with the function of an external memory 64, and asset inventory information of the corresponding real device 12 in a DB server 66 is read/written via the extended virtual device 60.

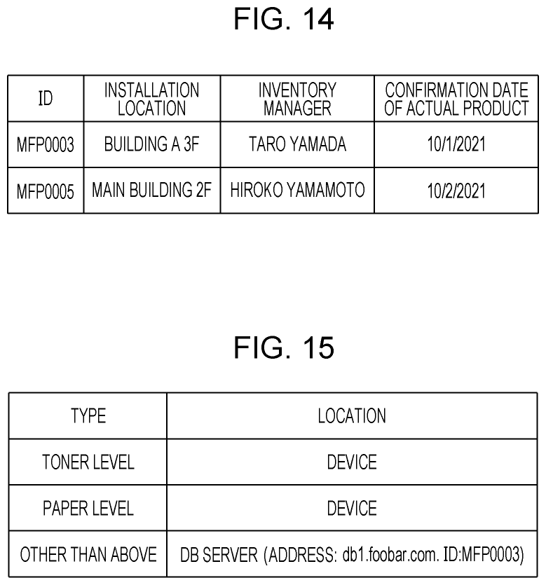

The DB server 66 stores information such as, for example, as illustrated in FIG. 14, the ID, the installation location, the inventory manager, and the confirmation date of the actual product of each real device 12. FIG. 14 is a diagram illustrating an example of data stored in the DB server 66.

Also in the modification, the function of a distinguishing unit 62 is provided, and the distinguishing unit 62 determines the access destination according to the type of requested information in accordance with a distinguishing rule as illustrated in FIG. 15 and reads/writes information. FIG. 15 is a diagram illustrating an example of access destinations according to the type of information as a distinguishing rule in the modification. In the example illustrated in FIG. 15, it is illustrated that, as types of information, toner level and paper level reside in the device, and other than toner level and paper level resides in the DB server 66.

In the modification, the processing similar to that in FIG. 12 is performed. Specifically, as the determination in step S104 in FIG. 12 described above, it is determined whether to access the DB server 66 instead of the extended storage area 56.

Here, the processing performed by the cloud server 14 will be described in detail using a specific example of the types of information.

For example, suppose that the management application 52 sends the following request to the address (DeviceA.foobar.com) of the extended virtual device 60 to obtain the confirmation date of the actual product of the real device A 12A.

### <GetRequest>

<confirmation date of actual product/>

### </GetRequest>

The distinguishing unit 62 of the extended virtual device 60 determines that the requested data, that is, the confirmation date of the actual product, is data stored in the DB server 66. Then, the external memory 64 of the extended virtual device 60 sends a query request to the address (db1.foobar.com) of the DB server 66, and searches for the value of the confirmation date of the actual product of a record whose ID is MFP0003. Based on the search result obtained from the DB server 66, a response message such as, for example, the following is generated and returned from the extended virtual device 60 the management application 52.

### <GetResult>

<confirmation date of actual product>10/1/2021</confirmation date of actual product>

### </GetResult>

The management application 52 centrally stores and manages information linked with the real device 12 by accessing the extended virtual device 60. How the real device A 12A is represented (such as the ID number) in the DB server 66 is managed only by the extended virtual device 60, and need not be of interest to the management application 52.

The operation in the case where the management application 52 sends a request to the address (DeviceA.foobar.com) of the extended virtual device 60 to obtain the toner level of the real device A 12A is the same as that in the above-described exemplary embodiment, and thus a description thereof is omitted.

Although the case of providing one extended storage area 56 and one DB server 66 has been described by way of example in the above exemplary embodiment, this is not the only possible case, and the extended storage area 56 and the DB server 66 may each be plural.

Although the image forming device 12 has been described as an example of a physical device in the above exemplary embodiment, a physical device is not limited to the image forming device 12. For example, another device such as an image processing device may be applied as a physical device.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, processing performed in the image forming system 10 according to the above exemplary embodiment may be processing performed by software, processing performed by hardware, or processing that combines both. Moreover, processing performed by each unit of the image forming system 10 may be stored as a program on a storage medium to be distributed.

The present disclosure is not limited to the above, and needless to say, in addition to the above, the present disclosure may be implemented in various modifications within a range not deviating from the gist thereof.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing device including:
a processor configured to:
   function as a virtual device that is provided one-to-one with a physical device and that mediates transmission and reception of information between an application and the physical device,
wherein, on acceptance of an instruction from the application to read/write information, the virtual device connects to a storage area determined in advance for each content of the information and reads/writes the information.
   (((2)))

The information processing device according to (((1))), wherein the virtual device duplicates and retains information of the physical device with timing determined in advance with the physical device.

(((3)))

The information processing device according to (((2))), wherein the processor is configured to connect to, in accordance with content of the information, a duplicate storage area that is provided in the virtual device and that duplicates and retains information of the physical device, an extended storage area that is provided in the virtual device separately from the duplicate storage area, or an external storage area that is provided outside the virtual device, and reads/writes the information.

(((4)))

The information processing device according to (((3))), wherein the processor is configured to connect to the duplicate storage area and read/write the information in a case where the content of the information is information of a type managed by the virtual device, and connects to the extended storage area or the external storage area and reads/writes the information in a case where the content of the information is information of a type managed by a device other than the virtual device.

(((5)))

An information processing system including:
the information processing device according to any one of (((1))) to (((4))); and a communication terminal in which the application is installed.
   (((6)))

An information processing program causing a computer to execute a process, the process comprising:
functioning as a virtual device that is provided one-to-one with a physical device and that mediates transmission and reception of information between an application and the physical device,
wherein, on acceptance of an instruction from the application to read/write information, the virtual device connects to a storage area determined in advance for each content of the information and reads/writes the information.

What is claimed is:

1. An information processing device comprising:
a processor configured to:
function as a virtual device that is provided one-to-one with a physical device and that mediates transmission and reception of information between an application and the physical device,
wherein, on acceptance of an instruction from the application to read/write information, the virtual device connects to a storage area determined in advance for each content of the information and reads/writes the information.

2. The information processing device according to claim 1, wherein the virtual device duplicates and retains information of the physical device with timing determined in advance with the physical device.

3. The information processing device according to claim 2, wherein the processor is configured to connect to, in accordance with content of the information, a duplicate storage area that is provided in the virtual device and that duplicates and retains information of the physical device, an extended storage area that is provided in the virtual device separately from the duplicate storage area, or an external storage area that is provided outside the virtual device, and reads/writes the information.

4. The information processing device according to claim 3, wherein the processor is configured to connect to the duplicate storage area and read/write the information in a case where the content of the information is information of a type managed by the virtual device, and connects to the extended storage area or the external storage area and reads/writes the information in a case where the content of the information is information of a type managed by a device other than the virtual device.

5. An information processing system comprising:
the information processing device according to claim 1; and
a communication terminal in which the application is installed.

6. A non-transitory computer readable medium storing a program causing a computer to execute a process for information processing, the process comprising:
functioning as a virtual device that is provided one-to-one with a physical device and that mediates transmission and reception of information between an application and the physical device,
wherein, on acceptance of an instruction from the application to read/write information, the virtual device connects to a storage area determined in advance for each content of the information and reads/writes the information.

7. An information processing method for a computer to execute a process, the process comprising:
functioning as a virtual device that is provided one-to-one with a physical device and that mediates transmission and reception of information between an application and the physical device,
wherein, on acceptance of an instruction from the application to read/write information, the virtual device connects to a storage area determined in advance for each content of the information and reads/writes the information.
